(19) United States
(12) Patent Application Publication
(10) Pub. No.: US 2021/0111783 A1
(43) Pub. Date: Apr. 15, 2021

(54) DATA TRANSMISSION METHOD AND DEVICE

(71) Applicants: SHARP KABUSHIKI KAISHA, Sakai City, Osaka (JP); FG INNOVATION COMPANY LIMITED, Tuen Mun, New Territories (HK)

(72) Inventors: CHONGMING ZHANG, Shanghai (CN); RENMAO LIU, Shanghai (CN)

(21) Appl. No.: 16/608,468

(22) PCT Filed: Apr. 10, 2018
(86) PCT No.: PCT/CN2018/082491

§ 371 Date: Oct. 25, 2019

(30) Foreign Application Priority Data
Apr. 28, 2017 (CN) 201710299812.4

(51) Int. Cl. H04B 7/08; H04W 76/19; H04W 16/28; H04W 72/04; H04W 76/27; H04W 80/02; H04L 1/18

(52) U.S. Cl. CPC H04B 7/088; H04W 76/19; H04W 16/28; H04W 72/042; H04L 1/1835; H04W 76/27; H04W 80/02; H04L 1/1819; H04W 72/046

(57) ABSTRACT

The present disclosure provides a method performed by user equipment (UE), comprising performing one or more of the following operations when the UE performs a beam recovery preparation procedure: stopping or suspending receiving a physical layer downlink control channel (PDCCH) on a failed beam or in a beam direction; saving a parameter related to one or more logical channels; or saving relevant information of a hybrid automatic repeat request (HARQ) process. One or more of the following corresponding operations are performed when a beam recovery procedure is complete: receiving a PDCCH on an operating beam or in a beam direction; recovering a parameter related to one or more logical channels; or recovering relevant information of an HARQ process. The present disclosure further provides user equipment.

### TECHNICAL FIELD

The present disclosure relates to the radio communication technology field. More specifically, the present disclosure relates to a data transmission method using beam forming and a corresponding device.

### BACKGROUND

With the rapid growth of mobile communication and great progress of technology, the world will move toward a fully interconnected network society where anyone or anything can acquire information and share data anytime and anywhere. It is estimated that there will be 50 billion interconnected devices by 2020, of which only about 10 billion may be mobile phones and tablet computers. The rest are not machines communicating with human beings but machines communicating with one another. Therefore, how to design a system to better support the Internet of Everything is a subject needing further and intensive study.

For this purpose, at the 3rd Generation Partnership Project (3GPP) RAN #64 plenary session held in March 2016, a research subject on new 5G radio access technology was proposed (see non-patent literature: RP-160671 New SID Proposal: Study on New Radio Access Technology). In the description of this work project, the operating frequency band of the future new communication system can be extended to 100 GHz, which can satisfy at least the requirements of enhanced mobile broadband services, the communication requirements of a large number of sets of UE in the Internet of Things, and the requirements of services requiring high reliability at the same time. The research work on this project is expected to end in 2018.

In the research of the subject, it is planned to perform data transmission using beams/beam forming, which specifically includes, during communication using high frequencies, transmitting narrow beams to cope with the characteristic of excessively fast fading of channels at high frequencies. However, information transmission using narrower beams is susceptible to external changes, for example, rotation of a mobile phone or blocking by other objects.

### SUMMARY

In transmission scenarios using beam forming, once a valid beam signal serving data/information transmission of UE weakens or is lower than a pre-configured threshold, the data/information transmission is interrupted. The UE will transmit relevant request information to a network to request reconfiguration of a valid operating beam. A problem that needs to be solved is how to ensure continuity of data transmission in this process.

According to one aspect of the present disclosure, a method performed by user equipment (UE) is provided. The method comprises performing one or more of the following operations when the UE performs a beam recovery preparation procedure: stopping or suspending receiving a physical layer downlink control channel (PDCCH) on a failed beam or in a beam direction; saving a parameter related to one or more logical channels; or saving relevant information of a hybrid automatic repeat request (HARQ) process. The method further comprises performing one or more of the following corresponding operations when a beam recovery procedure is complete: receiving the PDCCH on an operating beam or in a beam direction; recovering a parameter related to one or more logical channels; or recovering relevant information of the HARQ process.

In one embodiment, the UE performs the beam recovery preparation procedure when any of the following situations occurs: after failure of a radio link that uses beam forming is detected; the UE judges that the beam recovery procedure can be performed; before the UE determines to transmit a beam recovery request; or before the UE determines to transmit a radio link interruption recovery request.

In one embodiment, the beam recovery procedure is complete when any of the following situations occurs: the UE receives a valid beam recovery request response; the UE receives a valid radio link interruption recovery request response; or the UE obtains the operating beam.

In one embodiment, the failed beam or beam direction means that signal strength of the beam is lower than a specific threshold or that signal detection of a radio link in the beam direction does not meet specific requirements.

In one embodiment, the parameter related to the one or more logical channels comprises a parameter related to a transmission priority and/or a parameter related to a data transmission rate.

In one embodiment, the relevant information of the HARQ process comprises one or more of the following items:
an identifier of the HARQ process;
information in an HARQ buffer;
indication information related to HARQ data transmission; or
relevant information of a transmission time interval or subcarrier bandwidth of the HARQ process.

In one embodiment, the method further comprises receiving indication information of discarding the relevant information of the HARQ process and emptying buffers of all HARQS.

In one embodiment, the indication information is comprised in a MAC control element, downlink control information (DCI) of the PDCCH, or RRC signaling.

In one embodiment, the steps of the method described above are performed on a media access control (MAC) layer.

According to another aspect of the present disclosure, a method performed by a base station is provided. The method comprises receiving a beam recovery request or a radio link interruption recovery request transmitted by UE. The method further comprises transmitting indication information to the UE. For example, the base station may set the indication information in a beam recovery request response or a radio link interruption recovery request response message and transmit the beam recovery request response or the radio link interruption recovery request response message to the UE. The indication message may be used for instructing the UE to discard relevant information of the HARQ process.

According to another aspect of the present disclosure, user equipment (UE) comprising a processor and a memory is provided. The memory stores instructions that, when run by the processor, perform the method performed by user equipment (UE) described according to the present disclosure.

According to another aspect of the present disclosure, a base station comprising a processor and a memory is provided. The memory stores instructions that, when run by the processor, perform the method performed by a base station described according to the present disclosure.

### BRIEF DESCRIPTION OF DRAWINGS

The above and other features of the present disclosure will become more apparent with the following detailed description in conjunction with the accompanying drawings.

FIG. 1 is a flowchart of a method performed by user equipment according to an embodiment of the present disclosure.

FIG. 2 is a block diagram of user equipment according to an embodiment of the present disclosure.

FIG. 3 is a flowchart of a method performed by a base station according to an embodiment of the present disclosure.

FIG. 4 is a block diagram of a base station according to an embodiment of the present disclosure.

### DETAILED DESCRIPTION

The present disclosure is described in detail below with reference to the accompanying drawings and specific embodiments. It should be noted that the present disclosure should not be limited to the specific embodiments described below. In addition, for simplicity, detailed description of the known art not directly related to the present disclosure is omitted to avoid obscuring the understanding of the present disclosure.

In the following description, an NR mobile communications system and its later evolved versions are used as exemplary application environments; a base station and a UE device that support NR are used as examples to set forth, in detail, a plurality of embodiments of the present disclosure. However, it should be noted that the present disclosure is not limited to the following embodiments; the present disclosure is applicable to more other radio communications systems, such as an eLTE communications system and is applicable to other base stations and UE devices, such as base stations and UE devices supporting eLTE. Meanwhile, the present disclosure is not limited to scenarios of radio link interruption caused by beams/beam forming and may also be applied to scenarios of radio link interruption due to other causes.

Prior to the specific description, several terms mentioned in the present disclosure are described as follows. The terms involved in the present disclosure have the following meanings, unless otherwise indicated:

UE: User Equipment

RLF: Radio Link Failure

NR: New Generation Radio Technology

LTE: Long Term Evolution Technology

eLTE: Enhanced Long Term Evolution Technology

RRC: Radio Resource Control

PDCP: Packet Data Convergence Protocol Layer

RLC: Radio Link Control Layer

MAC: Media Access Control Layer

PHY: Physical Layer

MAC CE: Media Access Control Layer Control Element

PUCCH: Physical Layer Uplink Control Channel

PDCCH: Physical Layer Downlink Control Channel

PDSCH: Physical Layer Downlink Shared Channel

DCI: Downlink Control Information

TTI: Transmission Time Interval

NDI: New Data Indicator

HARQ: Hybrid Automatic Repeat Request

Beam Recovery Procedure: when UE detects that a radio link using beam forming fails, if the UE can detect another suitable beam in a current cell, then the UE may start a beam recovery procedure. The procedure may include transmitting, by the UE, a request to a base station to request reconfiguration of an operating beam or to request recovery of the interrupted radio link. The request may indicate the suitable beam detected by the UE. The base station transmits a response message to the UE after receiving the request. The base station may confirm, in the response message, to the UE that the beam indicated by the UE in the request can be used as a subsequent operating beam, or the base station configures an operating beam for the UE in the response message. Alternatively, the base station and the UE may perform subsequent information interaction to enable the UE to obtain an operation-capable beam. When the UE obtains the operation-capable beam, it may be considered that the beam recovery procedure successfully ends.

Several embodiments of the present disclosure are described in detail below.

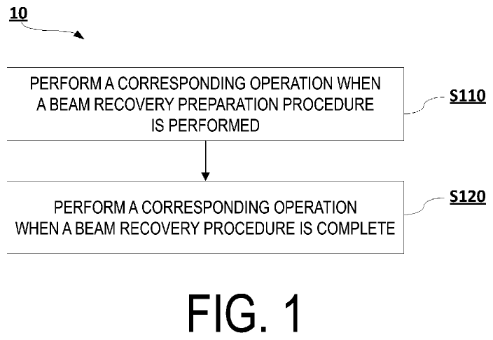

FIG. 1 is a flowchart of a method 10 performed by user equipment according to an embodiment of the present disclosure.

In step S110, when the UE performs a beam recovery preparation procedure, one or more operations may be performed. For example, the UE performs the beam recovery preparation procedure when any of the following situations occurs: after the UE detects failure of a radio link that uses beam forming; the UE judges that a beam recovery procedure can be performed; before the UE determines to transmit a beam recovery request; before the UE determines to transmit a radio link interruption recovery request; or the like. In addition, the UE may further perform the beam recovery preparation procedure in one or a plurality of the following situations:
before or when a random access procedure is performed, if the random access procedure is triggered for the reason of requesting beam recovery;
when the UE is preparing for beam recovery;
when the UE judges that a radio link interruption recovery procedure can be performed;
before or when the UE transmits a radio link interruption recovery request;
before or when a random access procedure is performed, if the random access procedure is triggered for the reason of requesting to recover from radio link interruption; and
when the UE is preparing for recovering from radio link interruption.

Specifically, when the UE performs the beam recovery preparation procedure, the UE may stop or suspend receiving a physical layer downlink control channel (PDCCH) on a failed beam or in a beam direction. For example, the failed beam or beam direction may mean that signal strength of the beam is lower than a specific threshold or that signal detection of a radio link in the beam direction does not meet specific requirements. Alternatively, it is also possible to stop or suspend receiving a PDSCH that is scheduled by the PDCCH or included in indication information of the PDCCH. One or a plurality of failed beams or beam directions may exist.

Alternatively, when the UE prepares to perform a beam recovery procedure, the UE may store a parameter related to one or more logical channels. For example, the parameter may include a parameter related to a transmission priority and/or a parameter related to a data transmission rate.

Alternatively, when the UE prepares to perform the beam recovery procedure, the UE may store relevant information of a hybrid automatic repeat request (HARQ) process. For example, the relevant information of the HARQ process may include one or more of the following items:
an identifier of the HARQ process;
information in an HARQ buffer;
indication information (for example, an NDI) related to HARQ data transmission; or
relevant information of a transmission time interval or subcarrier bandwidth of the HARQ process.

The aforementioned HARQ process may be an HARQ of uplink data transmission or an HARQ of downlink data transmission. In addition, the aforementioned HARQ process may be an HARQ process in a specified direction (for example, a specified uplink direction or a specified downlink direction), or may be the HARQ process of a specified HARQ ID, which are here collectively referred to as specified HARQs. The UE may save the aforementioned relevant information of a specified HARQ and release or delete relevant information of an unspecified HARQ. Here, the specified HARQ may be predefined or indicated to the UE by a network side/base station through signaling.

Alternatively, the UE may further empty buffers of all HARQs. For a downlink HARQ process, the UE may consider a transmission block received next time as a first transmission. In addition, the UE may further set indicators related to new data transmission of all uplink HARQ processes to 0 or an initial value.

Alternatively, when the UE prepares to perform the beam recovery procedure, the UE may cancel or suspend procedures triggered in other situations or procedures being processed by the UE, which include, but are not limited to, one or a plurality of the following procedures: a scheduling request procedure, a buffer status report procedure, a power-related report procedure, a random access procedure, and the like. The procedures triggered in other situations refer to processing procedures triggered by relevant processing of non-beam transmission (for example, beam transmission failure or a request for reconfiguration of a beam).

Alternatively, when the UE prepares to perform the beam recovery procedure, the UE may stop or suspend some or all timers on a MAC layer or an RLC layer or a PDCP layer. The timers include, but are not limited to, one or a plurality of the following timers: a timer related to a scheduling request procedure, a timer related to a buffer status report procedure, a timer related to a power-related report procedure, a timer related to a UE discontinuous reception procedure/function, and the like.

Step S120: when the beam recovery procedure is complete, the UE may perform one or more corresponding operations. For example, the beam recovery procedure is complete when any of the following situations occurs: when or after the UE receives a valid beam recovery request response; when or after the UE receives a valid radio link interruption recovery request response, the UE obtains an operating beam; at the time of or following radio link interruption recovery; or the like. The valid beam recovery request response or valid radio link interruption recovery request response means that the UE can obtain an operating beam according to information in the response.

Specifically, when the beam recovery procedure is complete, the UE may receive a PDCCH on an operating beam or in a beam direction. Alternatively, the UE may receive a corresponding PDSCH according to indication information/scheduling information in the PDCCH. The operating beam/beam direction obtained by the UE may be a radio link or radio link direction assigned by a network, or a radio link of which signal quality exceeds a specific threshold, or a radio link of which signal detection meets specific requirements. One or a plurality of valid operating beams/beam directions may exist.

Alternatively, when the beam recovery procedure is complete, the UE may recover a parameter related to one or more logical channels. For example, the parameter may include a parameter related to a transmission priority and/or a parameter related to a data transmission rate.

Alternatively, when the beam recovery procedure is complete, the UE may recover relevant information of the HARQ process. For example, the relevant information of the HARQ process may include one or more of the following items:
an identifier of the HARQ process;
information in a buffer of the HARQ process;
indication information (for example, an NDI) related to HARQ data transmission; or
relevant information of a transmission time interval or subcarrier bandwidth of the HARQ process.

The aforementioned HARQ process may be an HARQ of uplink data transmission or an HARQ of downlink data transmission. In addition, the aforementioned HARQ process may be the HARQ process in a specified direction (for example, a specified uplink direction or a specified downlink direction), or may be the HARQ process of a specified HARQ ID, which are here collectively referred to as specified HARQs. The UE may save the aforementioned relevant information of a specified HARQ and release or delete relevant information of an unspecified HARQ.

Alternatively, when the beam recovery procedure is complete, the UE may resume the suspended procedure, including, but not limited to, one or a plurality of the following procedures: a scheduling request procedure, a buffer status report procedure, a power-related report procedure, a random access procedure, and the like.

Alternatively, when the beam recovery procedure is complete, the UE may restart or resume some or all timers on a MAC layer, an RLC layer or a PDCP layer including, but not limited to, one or a plurality of the following timers: a timer related to a scheduling request procedure, a timer related to a buffer status report procedure, a timer related to a power-related report procedure, a timer related to a UE discontinuous reception procedure/function, and the like. The restart means that the UE directly starts a timer when judging that a previous trigger condition is still valid, or directly starts a timer when a trigger condition is again satisfied.

In one embodiment, the UE may receive indication information from the network side/base station, where the indication information may instruct the UE to discard saved HARQ-related information or recover saved HARQ-related information. The indication information may be included in a MAC control element, downlink control information (DCI) of the PDCCH, or RRC signaling. The indication information may be received before the UE transmits a beam recovery request or a radio link interruption recovery request, or may be carried in a beam recovery request response or a radio link interruption recovery request response received by the UE.

When the indication information is received before the UE transmits a beam recovery request or a radio link interruption recovery request, for example, received with a configuration of operating beam transmitted, then the UE may empty buffers of all HARQs when performing the beam recovery preparation procedure. For a downlink HARQ process, the UE may consider a transmission block received next time as a first transmission. In addition, the UE may further set indicators related to new data transmission of all uplink HARQ processes to 0 or an initial value.

If the indication information is carried in a beam recovery request response or a radio link interruption recovery request response received by the UE, when the indication information received by the UE instructs to discard HARQ-related information, the UE may empty buffers of all HARQs and optionally consider a transmission block received next time as a first transmission for a downlink HARQ process. In addition, the UE may further set indicators related to new data transmission of all uplink HARQ processes to 0 or an initial value.

Preferably, the aforementioned steps may be performed on a media access control (MAC) layer of the UE. Alternatively, an RRC layer may instruct the MAC to perform the aforementioned steps.

In another embodiment, the UE may reset or partially reset the MAC layer in the following situations:
when the UE judges that the beam recovery procedure can be performed;
before or when the UE transmits a beam recovery request;
before or when a random access procedure is performed, if the random access procedure is triggered for the reason of requesting beam recovery;
when the UE is preparing for beam recovery;
the preparation procedure for beam recovery includes the behavior;
when the UE judges that a radio link interruption recovery procedure can be performed;
before or when the UE transmits a radio link interruption recovery request;
before or when a random access procedure is performed, if the random access procedure is triggered for the reason of requesting to recover from radio link interruption;
when the UE is preparing for recovering from radio link interruption; or
preparation procedure for recovering from radio link interruption.

The resetting or partially resetting the MAC layer by the UE may include one or a plurality of the following actions:
releasing or initializing variables/parameters related to all logical channels;
stopping all running timers;
setting indicators related to data transmission of all uplink HARQ processes to 0 or an initial value;
stopping an ongoing random access procedure;
emptying the buffer of Message 3;
emptying buffers of all downlink HARQ processes; or
for each downlink HARQ process, using a transmission block received next time as a first transmission.

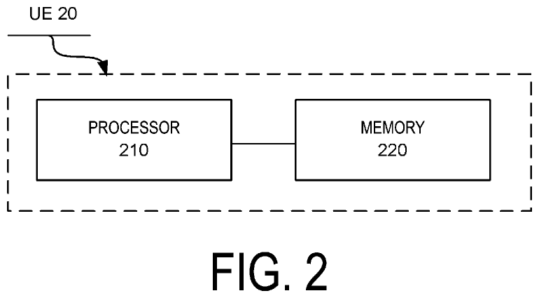

FIG. 2 is a block diagram of user equipment 20 according to an embodiment of the present disclosure. As shown in FIG. 2, the user equipment 20 includes a processor 210 and a memory 220. The processor 210 may, for example, include a microprocessor, a microcontroller, an embedded processor, or the like. The memory 220 may, for example, include a volatile memory (for example, a random access memory (RAM)), a hard disk drive (HDD), a non-volatile memory (for example, a flash memory), or other memories. Program instructions are stored on the memory 220. The instructions, when run by the processor 210, can perform the aforementioned method performed by user equipment described in detail in the present disclosure.

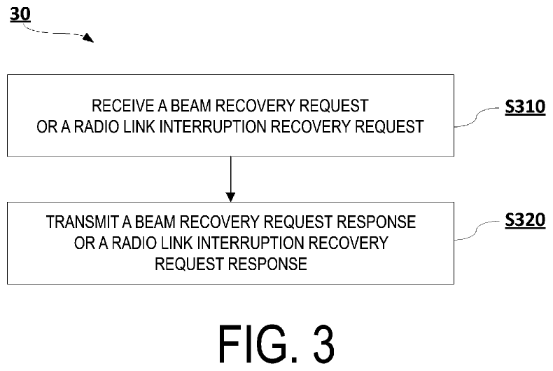

FIG. 3 is a flowchart of a method 30 performed by a base station according to an embodiment of the present disclosure.

Step S310: the base station receives a beam recovery request or a radio link interruption recovery request transmitted by UE. For example, the UE may transmit a beam recovery request or a radio link interruption recovery request to the base station after performing a beam recovery preparation procedure.

Step S320: the base station transmits indication information to the UE. Specifically, the base station may set the indication information in a beam recovery request response or a radio link interruption recovery request response message and transmit the beam recovery request response or the radio link interruption recovery request response message to the UE. The indication message may be used for instructing the UE to discard relevant information of an HARQ process.

Alternatively, the indication information may be transmitted to the UE when the base station transmits relevant information of a configuration of an operating beam to the UE. The transmitting behavior may occur before step S310.

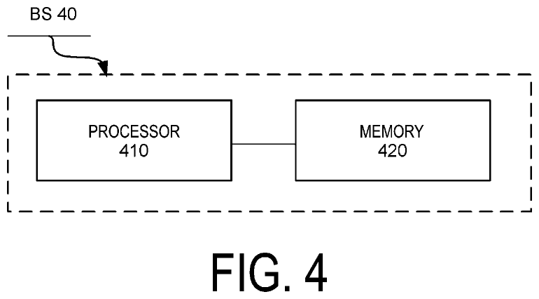

FIG. 4 is a block diagram of a base station 40 according to an embodiment of the present disclosure. As shown in FIG. 4, the base station 40 includes a processor 410 and a memory 420. The processor 410 may, for example, include a microprocessor, a microcontroller, an embedded processor, or the like. The memory 420 may, for example, include a volatile memory (for example, a random access memory (RAM)), a hard disk drive (HDD), a non-volatile memory (for example, a flash memory), or other memories. Program instructions are stored on the memory 420. The instructions, when run by the processor 410, can perform the aforementioned method performed by a base station described in detail in the present disclosure.

The program running on the device according to the present disclosure may be a program that enables a computer to implement the functions of the embodiments of the present disclosure by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present disclosure may be recorded on a computer-readable recording medium. The corresponding functions can be achieved by the computer system through reading programs recorded on the recording medium and executing them. The so-called “computer system” herein may be a computer system embedded in the device, which may include operating systems or hardware (for example, peripherals). The “computer-readable recording medium” may be a semiconductor recording medium, an optical recording medium, a magnetic recording medium, a recording medium for programs that are dynamically stored for a short time, or any other computer-readable recording medium.

Various features or functional modules of the device used in the above embodiments may be implemented or executed through circuits (for example, monolithic or multi-chip integrated circuits). Circuits designed to execute the functions described in this description may include general-purpose processors, digital signal processors (DSPs), application specific integrated circuits (ASICs), field programmable gate arrays (FPGAs) or other programmable logic devices, discrete gates or transistor logic, or discrete hardware components, or any combination of the above. The general-purpose processor may be a microprocessor, or may be an existing processor, a controller, a microcontroller, or a state machine. The circuit may be a digital circuit or an analog circuit. When new integrated circuit technologies that replace existing integrated circuits emerge because of the advances in semiconductor technology, one or a plurality of embodiments of the present disclosure may also be implemented using these new integrated circuit technologies.

Furthermore, the present disclosure is not limited to the embodiments described above. Although various examples of the embodiments have been described, the present disclosure is not limited thereto. Fixed or non-mobile electronic devices installed indoors or outdoors, such as AV equipment, kitchen equipment, cleaning equipment, air conditioners, office equipment, vending machines, and other household appliances, may be used as UE devices or communications devices.

The embodiments of the present disclosure have been described in detail above with reference to the accompanying drawings. However, the specific structures are not limited to the above embodiments. The present disclosure also includes any design modifications that do not depart from the substance of the present disclosure. In addition, various modifications can be made to the present disclosure within the scope of the claims. Embodiments resulted from the appropriate combinations of the technical means disclosed in different embodiments are also included within the technical scope of the present disclosure. In addition, components with the same effect described in the embodiments above may be replaced with one another.

1. A method performed by user equipment (UE), comprising:
performing one or more of the following operations when the UE performs a beam recovery preparation procedure:
stopping or suspending receiving a physical layer downlink control channel (PDCCH) on a failed beam or in a beam direction;
saving a parameter related to one or more logical channels; or
saving relevant information of a hybrid automatic repeat request (HARQ) process; and
performing one or more of the following corresponding operations when a beam recovery procedure is complete:
receiving the PDCCH on an operating beam or in the beam direction;
recovering a parameter related to one or more logical channels; or
recovering the relevant information of the HARQ process.

2. The method according to claim 1, wherein the UE performs the beam recovery preparation procedure when any of the following situations occurs:
after failure of a radio link that uses beam forming is detected;
the UE judges that the beam recovery procedure can be performed;
before the UE determines to transmit a beam recovery request; or
before the UE determines to transmit a radio link interruption recovery request.

3. The method according to claim 1, wherein the beam recovery procedure is complete when any of the following situations occurs:
the UE receives a valid beam recovery request response;
the UE receives a valid radio link interruption recovery request response; or
the UE obtains the operating beam.

4. The method according to claim 1, wherein the failed beam or beam direction comprises that signal strength of the beam is lower than a specific threshold or that a signal detection of a radio link in the beam direction does not meet specific requirements.

5. The method according to claim 1, wherein the parameter related to the one or more logical channels comprises a parameter related to a transmission priority and/or a parameter related to a data transmission rate.

6. The method according to claim 1, wherein the relevant information of the HARQ process comprises one or more of the following items:
an identifier of the HARQ process;
information in an HARQ buffer;
indication information related to HARQ data transmission; or
relevant information of a transmission time interval or subcarrier bandwidth of the HARQ process.

7. The method according to claim 1, further comprising:
receiving indication information of discarding the relevant information of the HARQ process; and
emptying buffers of all HARQS.

8. The method according to claim 7, wherein the indication information is comprised in a MAC control element, downlink control information (DCI) of the PDCCH, or RRC signaling.

9. The method according to claim 1, wherein the steps are performed on a media access control (MAC) layer.

10. User equipment (UE), comprising:
a processor; and
a memory, the memory having instructions stored thereon, wherein
the instructions, when run by the processor, perform the method according to claim 1.
